(19) United States
(12) Patent Application Publication
(10) Pub. No.: US 2008/0238819 A1
(43) Pub. Date: Oct. 2, 2008

(54) DIFFERENTIAL SIGNALING SYSTEM AND FLAT PANEL DISPLAY WITH THE SAME

(76) Inventor: Jee-youl Ryu, Suwon (KR)

Correspondence Address: CHRISTIE, PARKER & HALE, LLP, PO BOX 7068, PASADENA, CA, 91109-7068, US

(21) Appl. No.: 12/060,696

(22) Filed: Apr. 1, 2008

(30) Foreign Application Priority Data
Apr. 2, 2007 (KR) 10-2007-0032574

(51) Int. Cl. G09G 3/20

(52) U.S. Cl. 345/55

(57) ABSTRACT

A differential signaling system that clearly detects a presence of an impedance mismatch utilizing a test circuit in a flat panel display using a signal transmission method for transmitting a differential signal. A first transmission line and a second transmission line are coupled between a transmitter and a receiver as a differential signal line. A termination resistor is coupled between the first transmission line and the second transmission line at the receiver. A test circuit is coupled in parallel to the termination resistor, and detects a minute variation of differential impedance due to the differential signal line. The test circuit includes a differential test amplifier for amplifying a differential voltage responsive to a minute variation in an impedance of the first transmission line or the second transmission line, and two switches coupled to input terminals of the differential test amplifier for controlling an operation of the differential test amplifier.

### CROSS-REFERENCE TO RELATED APPLICATIONS

This application claims priority to and the benefit of Korean Patent Application No. 10-2007-0032574, filed on Apr. 2, 2007, in the Korean Intellectual Property Office, the entire content of which is incorporated herein by reference.

### BACKGROUND

1. Field of the Invention

The present invention relates to a flat panel display using a differential signal transmission method, and more particularly to an impedance matching system in the differential signal transmission method.

2. Discussion of Related Art

In general, a cathode ray tube (CRT) is a display device that has been widely used. The CRT has been used as a monitor for a television, a measuring instrument, and an information terminal. Since the CRT is heavy and has a large size, it cannot accommodate modern demand for miniaturization and weight reduction.

Accordingly, in order to replace the CRT, various flat panel displays such as liquid crystal displays (LCDs), plasma display panels (PDPs), field emission displays (FEDs), and organic light emitting displays (OLEDs) that have advantages in miniaturization, weight reduction, and low electric power consumption, have been studied and developed.

As described above, flat panel displays include various components and signal lines for transmitting signals between the components.

Recently, with the development of electronic circuit and manufacturing process technology, signals can be transmitted through the lines at high speed. To meet the signal transmission at high speed, a drive speed of the components has become high.

Accordingly, various methods for transmitting signals between the components through signal lines have been suggested. For example, a signal transmission method such as a low voltage differential signal (LVDS) method or a reduced swing differential signaling (RSDS) method for transmitting a differential signal has been used.

A differential signaling system transmits a different mode signal having the same amplitude and a different polarity through a differential transmission line. Accordingly, the magnetic field in the differential transmission line tends to be cancelled, and the electric field tends to be added. Because of the added electric field, a high speed signal can be stably transmitted without a signal reflection, a skew (phase delay, etc.), or electro magnetic interference (EMI).

A conventional flat panel display will be described with reference to the accompanying drawings in detail.

FIG. 1 is a block diagram showing a construction of a flat panel display.

With reference to FIG. 1, the flat panel display includes a display panel 40, a gate driver 20, a data driver 30, and a controller 10. Pixels are arranged in the display panel 40 in a matrix. The gate driver 20 sequentially applies a scan signal to gate lines of the display panel 40. The data driver 30 applies an image signal DATA1 to data lines of the display panel 40. The controller 10 applies the image signal DATA1 from an external graphic controller (not shown) to the data driver 30, and applies a control signal CS1 to the gate driver 20 and the data driver 30 in order to control a drive timing.

In the flat panel display, after the gate lines of the display panel 40 are sequentially scanned and the image signal DATA1 is applied to the pixels through the data lines to display one frame of an image, a vertical synchronization signal VSYNC is applied to display a next frame of the image.

FIG. 2 is a block diagram showing the controller and the data driver shown in FIG. 1 in detail. FIG. 3 is a view showing a signal transmission method between the controller and the data driver.

With reference to FIG. 2, the data driver 130 includes a plurality of driving circuits 132. The plurality of driving circuits 132 receive image signals DATA [+,−] from the controller 110 through first and second transmission lines W1 and W2, and receive a control signal CS11 from the controller 110 through a third line W3.

The driving circuits 132 receive image signals DATA [+,−] from the controller 110, and output them to the data lines according to the control signal CS11 from the controller 110.

Although they are not shown in drawings, a plurality of data lines are electrically coupled to the output of the driving circuits 132, and apply the image signals DATA [+,−] applied to the driving circuits 132 to the pixels.

Here, the image signal from the controller is transmitted to the respective data driving circuits in the aforementioned differential signal transmission method.

That is, as shown in FIG. 3, in order to transmit one data group DATA [+,−], a differential transmission line arrangement, namely, first and second transmission lines W1 and W2 are provided between the controller 110 being a transmitter Tx and the driving circuit 132 being a receiver Rx.

A termination resistor R_{T} is provided between differential transmission lines at the receiver (driving circuit 132) side. The termination resistor R_{T} electrically connects the first transmission line W1 and the second transmission line W2 to each other, which are coupled to each driving circuit 132.

Accordingly, the image signal DATA [+] applied through the first transmission line W1 is transferred to the controller 110 through the termination resistor R_{T} and the second transmission line W2. The termination resistor R_{T} prevents an excessive current from flowing to the driving circuit 132. A voltage across the termination resistor R_{T} is the image signal DATA [+,−], and is applied to the driving circuit 132.

A plurality of electrical devices and signal lines are provided in the flat panel display, which are electrically coupled to each other. Since the electrical devices and signal lines have an impedance component, they attenuate a signal during a signal transmission between the electric devices.

For example, the controller 110 and the driving circuits 132 have an impedance component. Further, the first and second transmission lines W1 and W2 for connecting the controller 110 and the driving circuits 132 have an impedance component Z0.

If the impedance value Z0 of the first and second transmission lines W1 and W2 is different from that of the driving circuits 132, namely, when an impedance mismatch occurs, the image signals DATA[+,−] are not precisely supplied to the driving circuits 132. That is, a part of the image signals is reflected and discharged.

In detail, a reflection coefficient Γ is expressed by the following equation 1.

$$Γ = \frac{{Z}_{diff} - {R}_{T}}{{Z}_{diff} + {R}_{T}} \qquad ( 1 )$$

where differential impedance Z_{diff} is a value less than 2Z0, which is a sum of impedance values of the first and second transmission lines W1 and W2, and has a different value according to manufacturing process variables and construction of the flat panel display.

Namely, when the differential impedance Z_{diff} is identical to a value of the termination resistor, a reflection loss of a signal does not occur. However, the differential impedance Z_{diff} varies. Accordingly, in the conventional case, impedance matching is not normally achieved in the differential transmission method.

When a reflection wave occurs due to an impedance mismatch, an interference with the image signals DATA [+,−] applied through the first transmission line W1 occurs, causing an unstable wave, signal distortion and attenuation. The electromagnetic interference (EMI) deteriorates the image quality of the flat panel display.

Because a conventional method for detecting the minute variation in the differential impedance has a long measuring time and uses measuring equipment of high cost, it has disadvantages that testing cost is increased and a detection rate for the minute variation is low.

### SUMMARY OF THE INVENTION

Accordingly, it is an aspect of the present invention to provide a differential signaling system that clearly detects a presence of an impedance mismatch utilizing a test circuit in a flat panel display using a signal transmission method for transmitting a differential signal such that an impedance matching can be precisely performed through the detection, such that a high speed signal can be stably transmitted without an electro magnetic interference. In one embodiment, the test circuit amplifies a voltage responsive to a minute variation of differential impedance to facilitate the detection of an impedance mismatch.

The foregoing and/or other aspects of an exemplary embodiment of the present invention are achieved by providing a differential signaling system including a first transmission line and a second transmission line coupled between a transmitter and a receiver as a differential signal line, with a termination resistor coupled between the first transmission line and the second transmission line at the receiver. A test circuit is coupled in parallel to the termination resistor. The test circuit includes a differential test amplifier for amplifying a differential voltage responsive to a minute variation in transmission line impedance of the first transmission line or the second transmission line; and two switches coupled to input terminals of the differential test amplifier for controlling an operation of the differential test amplifier.

According to a further embodiment, the test circuit is outside the receiver. The differential test amplifier may also have an input impedance and an amplification gain.

According to a second exemplary embodiment of the present invention, a flat panel display includes a display panel in which a plurality of data lines cross a plurality of gate lines. A controller outputs the image signal through the first and second transmission lines, the first and second transmission lines forming a differential signal line. A gate driver applies a scan signal to the gate lines, and a data driver including a plurality of driving circuits receives an image signal from the controller through the first and second transmission lines and applies the image signal to the data lines. A test circuit is coupled in parallel to the termination resistor. The test circuit includes a differential test amplifier for amplifying a differential voltage across the differential signal line responsive to a minute variation in an impedance of the first transmission line or the second transmission line, and two switches coupled to input terminals of the differential test amplifier control an operation of the differential test amplifier.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram showing a construction of a conventional flat panel display;

FIG. 2 is a block diagram showing a controller and a data driver shown in FIG. 1 in detail;

FIG. 3 is a view showing a signal transmission method between the controller and the data driver;

FIG. 4 is a block diagram showing a construction of a flat panel display according to an exemplary embodiment of the present invention;

FIG. 5 is a detailed view showing an example of the controller and the data driver shown in FIG. 4;

FIG. 6 is a view showing a differential signaling system according to an exemplary embodiment of the present invention; and

FIG. 7 is an equivalent circuit diagram of the differential signaling system shown in FIG. 6.

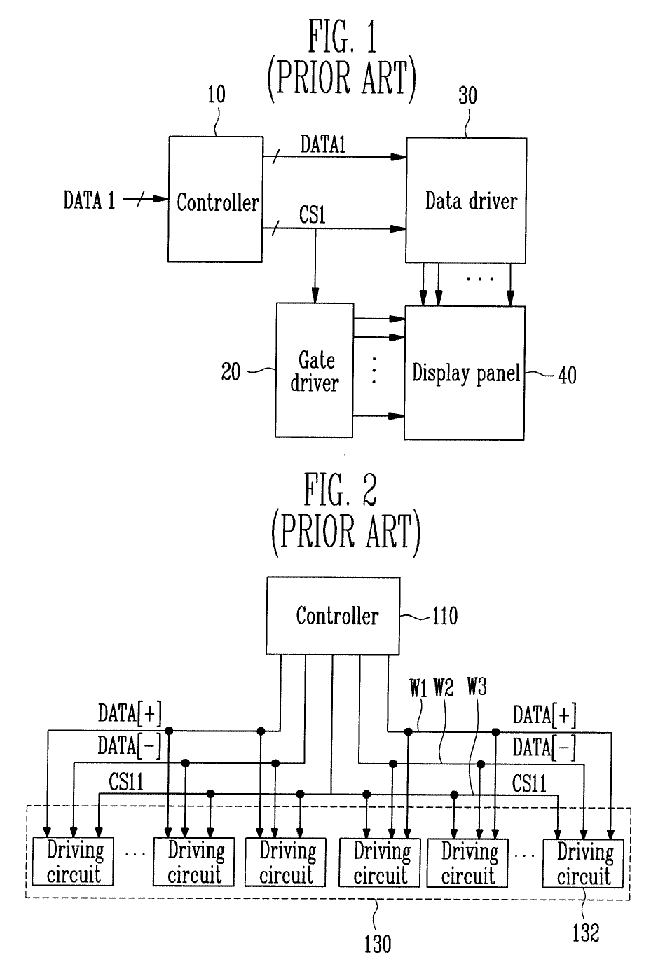

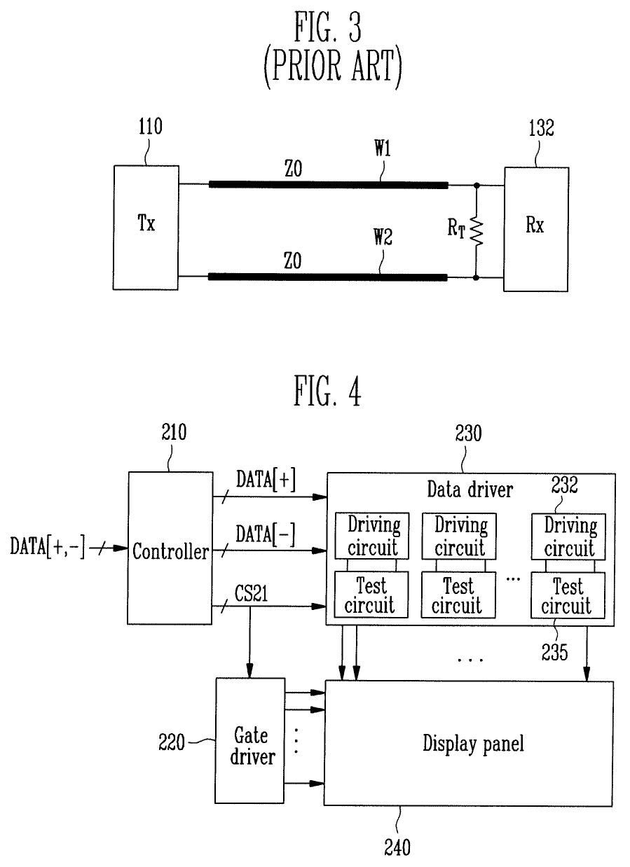

### DETAILED DESCRIPTION OF EXEMPLARY EMBODIMENTS

Hereinafter, exemplary embodiments according to the present invention will be described with reference to the accompanying drawings. Here, when one element is described to be coupled to another element, the one element may be directly coupled to the another element, or alternatively, may be indirectly coupled to the another element via a third element. Further, some elements unnecessary for a complete understanding of the invention are omitted for clarity. Also, like reference numerals refer to like elements throughout.

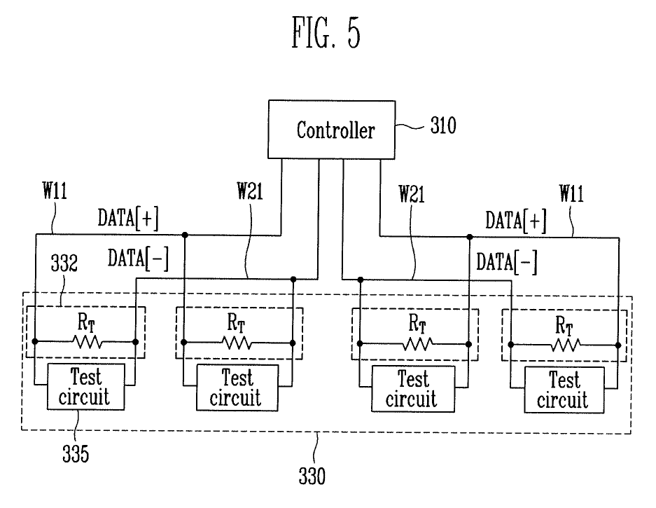

FIG. 4 is a block diagram showing a construction of a flat panel display according to an exemplary embodiment of the present invention.

With reference to FIG. 4, the flat panel display according to an exemplary embodiment of the present invention includes a display panel 240, a gate driver 220, a data driver 230, and a controller 210. Gate lines and data lines are arranged to cross each other on the display panel 240. The gate driver 220 sequentially applies a scan signal to the gate lines of the display panel 240. The data driver 230 applies an image signal DATA [+,−] to the data lines of the display panel 240. The controller 210 applies the image signal DATA [+,−] from an external graphic controller (not shown) to the data driver 230, and applies a control signal CS21 to the gate driver 220 and the data driver 230 in order to control a drive timing.

Further, a flat panel display according to an exemplary embodiment of the present invention is a flat panel display utilizing a signal transmission method for transmitting a differential signal. A test circuit 235 detects a presence of an impedance mismatch in a differential signaling method. The test circuit is coupled to a receiving end side, and amplifies a differential voltage responsive to a minute variation in transmission line impedance to clearly detect the presence of an impedance mismatch.

In the display panel 240, a plurality of gate lines may be arranged to be spaced apart from each other at a constant interval in a transverse direction, and a plurality of data lines may be arranged to be spaced apart from each other in a longitudinal direction. The gate lines and the data lines cross each other to define a plurality of regions. The regions are referred to as ‘pixels’. The pixels are electrically coupled to the gate lines and the data lines, and are arranged on the display panel 240 in a matrix-like pattern.

The controller 210 represents a timing controller. The controller 210 receives image signals DATA [+,−] from an exterior and generates various control signals CS21 to drive the flat panel display. The controller 210 applies the image signals DATA [+,−] to the data driver 230, and applies the control signal CS21 to the gate driver 220 and the data driver 230 to control a drive timing. Here, the controller 210 applies the control signal CS21 including a vertical synchronization signal VSYNC, a horizontal synchronization signal HSYNC, a clock signal, a gate start signal, and a data output enable signal to the gate driver 220 and the data driver 230 to control a drive timing of the gate driver 220 and the data driver 230.

That is, the controller 210 applies the horizontal synchronization signal HSYNC and the gate start signal to the gate driver 220 to sequentially apply a scan signal to the gate lines of the display panel 240. Further, the controller 220 applies the horizontal synchronization signal HSYNC, the data output enable signal, and the image signals DATA [+,−] to the data driver 230, so that the image signals DATA [+,−] are applied to the pixels coupled to the gate line to which the scan signal is applied. This causes the drive timing of the gate driver 220 and the data driver 230 to be controlled.

The data driver 230 is electrically coupled to the display panel 240 through the data lines. The data driver 230 includes a plurality of driving circuits 232. Each of the driving circuits 232 receives the image signals DATA [+,−] and the control signal CS21 from the controller 210, and outputs them to the data lines.

A test circuit 235 is coupled to input terminals of each of the driving circuits 232. Here, the driving circuit 232 receives the image signals DATA [+,−] from the controller 210. The test circuit 235 amplifies a differential voltage responsive to a minute variation in transmission line impedance from the controller 210 to the driving circuits 232 to clearly detect the presence of the impedance mismatch.

Here, as shown, the test circuit 235 can be mounted at a receiving end, namely, inside of the driving circuit 232. However, for a user's operation control convenience, the test circuit 235 may be mounted at an outside of the driving circuit 232.

The following is a detailed description of the construction and operation of the test circuit 235 with reference to the accompanying drawings.

The gate driver 220 receives a control signal CS21 from the controller 210, and sequentially applies a scan signal to the gate lines to drive pixels arranged in a matrix. The data driver 230 applies the image signals DATA [+,−] through the data lines to the pixels to which the scan signal is applied.

Through the aforementioned operation, after all gate lines of the display panel 240 are sequentially scanned and the image signals DATA [+,−] are applied to the pixels through the data lines to display one frame of an image, the vertical synchronization signal VSYNC is applied to display the next frame.

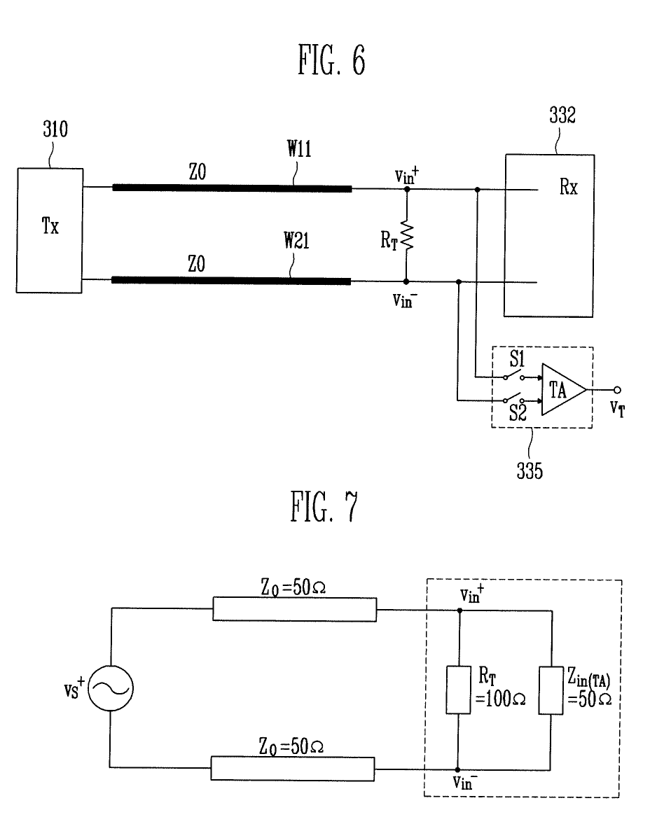

FIG. 5 is a detailed view showing an example of the controller and the data driver shown in FIG. 4. FIG. 6 is a view showing a differential signaling system according to an exemplary embodiment of the present invention. Namely, FIG. 6 is a view illustrating a signal transmission method between the controller 310 and the data driver 332 shown in FIG. 5.

FIG. 7 is an equivalent circuit diagram of the differential signaling system shown in FIG. 6.

With reference to FIG. 5, the flat panel display according to an exemplary embodiment of the present invention includes a controller 310 and a data driver 330. The controller 310 receives the image signals DATA [+,−] from an exterior and applies them to the first and second transmission lines W11 and W21. The data driver 330 includes a plurality of driving circuits 332. The plurality of driving circuits 332 match an impedance with the exterior, and receive the image signals DATA [+,−] from the controller 310 through the first and second wirings W11 and W21.

The controller 310 and the driving circuits 332 transmit the image signals and the control signal, for example, by a low voltage differential signaling (LVDS) transmission method, which transmit signals at high speed.

That is, the controller 310 is electrically coupled to the data driver 330 through the first and second transmission lines W11 and W21. The data driver 330 includes a plurality of driving circuits 332. Each of the driving circuits 332 receives the image signals DATA [+,−] from the controller 310 through the first and second transmission lines W1 and W2. However, for convenience of description, a wiring for supplying a control signal CS21 is omitted in FIG. 5. A pair of first and second transmission lines W11 and W21 is coupled to each driving circuit 332. However, in practice, plural pairs of the first and second transmission lines W11 and W21 can be coupled to each driving circuit 332.

The first and second transmission lines W11 and W21 are coupled to the driving circuit 332, and the first and second transmission lines W11 and W21 are electrically coupled through a termination resistor R_{T} to form a closed circuit.

Accordingly, the image signals DATA [+,−] applied from the controller 310 are applied to the terminal resistor R_{T} with a voltage. The termination resistor R_{T} prevents an excessive current from flowing in the driving circuit 332, and applies a voltage (e.g., a predetermined voltage) indicating the image signals DATA [+,−] to the driving circuit 332.

Namely, as shown in FIG. 6, in order to transmit one data group DATA [+,−], a differential transmission line arrangement, namely, first and second transmission lines W11 and W21 are provided between the controller 310 (being a sending end Tx) and the driving circuit 332 (being a receiving end Rx). A termination resistor R_{T} is provided between the differential transmission lines of the driving circuit, being the receiving end. The termination resistor R_{T} electrically connects the first and second transmission lines W11 and W21 coupled to each driving circuit 332 to form a closed circuit.

As described earlier, when only the termination resistor R_{T} is coupled between the differential transmission lines, since the differential impedance Z_{diff} can vary due to external factors, impedance matching cannot be normally achieved in the differential transmission method if a variation of the differential impedance is not precisely detected.

So as to address the problem, in an exemplary embodiment of the present invention, the test circuit 335 is coupled to the termination resistor R_{T} in parallel. The test circuit 335 amplifies a differential voltage responsive to the minute variation of transmission line impedance and converts the amplified signal into a direct current component, thereby easily detecting the presence of an impedance mismatch.

According to various embodiments, the test circuit 335 may be mounted inside of a receiving end (i.e., a receiver), or may be positioned outside of and coupled to the receiving end.

That is, the test circuit 335 can be mounted at a receiving end, namely, inside of the driving circuit 332. However, for a user's operation control convenience, the test circuit 335 can be installed outside the driving circuit 332, as shown in FIG. 5.

As shown in FIG. 6 according to an exemplary embodiment of the present invention, the test circuit 335 includes a differential test amplifier TA and two switches S1 and S2. The differential test amplifier TA amplifies a differential voltage responsive to a minute variation in transmission line impedance. The two switches S1 and S2 are installed at an input terminal of the differential test amplifier TA.

The differential test amplifier TA has an input impedance of 50 ohm, and an amplification gain G (which may be predetermined). The differential test amplifier TA amplifies a differential voltage responsive to a minute variation in transmission line impedance by a factor of the gain G. Namely, the differential test amplifier TA amplifies a differential signal component but removes or suppresses a high frequency common mode noise component.

Here, it is preferred that a high frequency amplifier embodies the differential test amplifier TA. Also, the switches S1 and S2 should be high-speed switches with low loss. The position in time when the voltage inputted through the differential transmission lines is measured, is controlled through the operation of the switches S1 and S2.

FIG. 7 is an equivalent circuit diagram of the differential signaling system shown in FIG. 6.

That is, when it is assumed that an input impedance Z_{in(TA)} is 50Ω, a termination resistance R_{T} is 100Ω, and an impedance Z₀ of each transmission line is 50Ω), the differential signaling system can be expressed by an equivalent circuit diagram as shown in FIG. 7.

However, the equivalent circuit diagram shows a case that two switches S1 and S2 included in an input terminal of the differential test amplifier are closed. When the two switches S1 and S2 are closed, it can be used to measure a minute variation in the value of the transmission line impedance.

The following is a measuring operation and a principle thereof for the minute variation of the transmission line impedance in the differential signaling system according to an exemplary embodiment of the present invention with reference to FIG. 7.

The measuring principle for the minute variation of the differential impedance in the differential signaling system according to an exemplary embodiment of the present invention is to detect a deviation between the impedance Z₀ of the transmission line and two input impedances, namely, the termination resistance R_{T} and an input impedance Z_{in(TA)} of the differential test amplifier.

Namely, the differential test amplifier included in the test circuit detects the aforementioned deviation. When defects in the transmission line or impedance mismatching due to a minute variation occur, an output voltage of the differential test amplifier is measured to determine a variation degree.

With reference to FIG. 6 and FIG. 7, input and output voltages of the test circuit when no defects occur in the transmission line, can be expressed by the following equations 2 and 3 (where the symbol 11 represents a parallel combination of two impedances).

$$\begin{matrix}\begin{matrix}{v}_{in}^{+} - {v}_{in}^{-} = \frac{( {R}_{T} \vert \vert {Z}_{in ( TA )} )}{2 {Z}_{0} + ( {R}_{T} \vert \vert {Z}_{in ( TA )} )} {v}_{{s}^{+}} \\ = \frac{( 100 \vert \vert 50 )}{100 + ( 100 \vert \vert 50 )} {v}_{{s}^{+}} \\ = \frac{1}{4} {v}_{{s}^{+}} \\ = 0.25 {v}_{{s}^{+}}\end{matrix} & Equation 2 \\ {v}_{T} = G \times ( {v}_{in}^{+} - {v}_{in}^{-} ) = 0.25 {Gv}_{{s}^{+}} & Equation 3\end{matrix}$$

where G represents a voltage gain of the differential test amplifier, and vₛ₊ and vₛ₋ represent input voltages to the test amplifier TA, which depend on a data voltage transmitted through the transmission lines.

For example, when the gain G is 10, and v_{S+} is 500 mV, input and output voltages of the test circuit 335 are expressed by the following equations 4 and 5.

vᵢₙ⁺−vᵢₙ⁻=0.25×500 mV=75 mV Equation 4

v_{T}=10×75 mV=750 mV Equation 5

In contrast to this, input and output voltages of the test circuit 335 when defects occur in the transmission line, can be expressed by the following equations 6 and 7.

$$\begin{matrix}\overline{{v}_{in}^{+} - {v}_{in}^{-}} = \frac{( {R}_{T} \vert \vert {Z}_{in ( TA )} )}{2 {Z}_{0} + ( {R}_{T} \vert \vert {Z}_{in ( TA )} )} {v}_{{s}^{+}} & Equation 6 \\ \overline{{v}_{T}} = G \times \overline{( {v}_{in}^{+} - {v}_{in}^{-} )} & Equation 7\end{matrix}$$

Namely, the bar (−) indicates input and output voltages of the test circuit when defects occur in the transmission line.

For example, when the impedance Z₀ of the transmission lines changes from 50Ω to 25Ω due to unexpected ambient environment, namely, when a differential impedance Z_{diff} is generated, the equations 6 and 7 can be expressed by the following equations 8 and 9.

$$\begin{matrix}\begin{matrix}\overline{{v}_{in}^{+} - {v}_{in}^{-}} = \frac{( 100 \vert \vert 50 )}{50 + ( 100 \vert \vert 50 )} {v}_{{s}^{+}} \\ = 0.4 {v}_{{s}^{+}} \\ = 0.4 \times 500 mV \\ = 200 mV\end{matrix} & Equation 8 \\ \overline{{v}_{T}} = 10 \times 200 mV = 2 V & Equation 9\end{matrix}$$

As understood through the aforementioned operation, when the impedance Z₀ of the transmission line changes by 50%, namely, from 50Ω to 25Ω, it is observed that an output voltage of the test circuit changes from 750 mV to 2V. Since this means a great voltage variation, a variation degree thereof can be easily detected.

In other words, the exemplary embodiment of the present invention may clearly detect a presence of an impedance mismatch with a test circuit in a flat panel display using a signal transmission method for transmitting a differential signal, and clearly enable a precise impedance matching through the detection. The test circuit amplifies a differential voltage responsive to a minute variation in transmission line impedance and converts the amplified signal into a direct current, thereby easily detecting the presence of an impedance mismatch.

Those of ordinary skill in the art would appreciate that the present described embodiment of the invention has better effect in comparison with a case of measuring across a termination resistor R_{T} without the test circuit.

In a case that an input voltage v_{S+} is 500 mV, measuring voltages before a variation and after 50% variation of impedance in the transmission lines in a prior art case without the test circuit, are expressed by following equations 10 and 11, respectively.

$$\begin{matrix}{v}_{in}^{+} - {v}_{in}^{-} = \frac{{R}_{T}}{2 {Z}_{0} + {R}_{T}} {v}_{{s}^{+}} = \frac{100}{200} ( 500 mV ) = 250 mV & Equation 10 \\ \overline{{v}_{in}^{+} - {v}_{in}^{-}} = \frac{{R}_{T}}{2 \overline{{Z}_{0}} + {R}_{T}} {v}_{{s}^{+}} = \frac{100}{150} ( 500 mV ) \approx 333 mV & Equation 11\end{matrix}$$

That is, a measuring voltage variation rate≈(333−250)×100%/250=33%.

Meanwhile, in the embodiment of the present invention described earlier, measuring voltages before a variation and after 50% variation of impedance in the transmission lines are expressed by the equations 4 and 8.

Namely, the measuring voltage variation rate=(2000−750)×100%/750=140%.

Accordingly, in the embodiment of the present invention, since the test circuit amplifies and detects a minute variation of differential impedance due to defects in the transmission line, it has a greater measuring voltage variation rate in comparison with a prior art. Accordingly, the present invention can precisely detect a minute variation and enables a precise impedance matching through the detection.

As is seen from the forgoing description, the embodiments of the present invention may clearly detect a presence of an impedance mismatch by a test circuit in a flat panel display using a signal transmission method for transmitting a differential signal and enables a precise impedance matching through the detection in order to stably transmit a high speed signal without an electromagnetic interference. The test circuit amplifies a differential voltage responsive to a minute variation in transmission line impedance and converts the amplified signal into a direct current component, thereby easily detecting the presence of an impedance mismatch.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A differential signaling system comprising:
a first transmission line and a second transmission line coupled between a transmitter and a receiver as a differential signal line;
a termination resistor coupled between the first transmission line and the second transmission line at or near the receiver; and
a test circuit coupled in parallel to the termination resistor,
wherein the test circuit comprises:
a differential test amplifier for amplifying a differential voltage responsive to a minute variation in transmission line impedance of the first transmission line or the second transmission line; and
two switches coupled to input terminals of the differential test amplifier for controlling an operation of the differential test amplifier.

2. The differential signaling system as claimed in claim 1, wherein the test circuit is outside the receiver.

3. The differential signaling system as claimed in claim 1, wherein the differential test amplifier has an input impedance and an amplification gain.

4. A flat panel display comprising:
a display panel comprising a plurality of data lines crossing a plurality of gate lines;
a controller for outputting an image signal through a first transmission line and a second transmission line, the first and second transmission lines forming a differential signal line;
a termination resistor coupled between the first transmission line and the second transmission line;
a gate driver for applying a scan signal to the gate lines;
a data driver comprising a plurality of driving circuits for receiving an image signal from the controller through the first and second transmission lines and applying the image signal to the data lines; and
a test circuit coupled in parallel to the termination resistor,
wherein the test circuit comprises:
a differential test amplifier for amplifying a differential voltage across the differential signal line responsive to a minute variation in an impedance of the first transmission line or the second transmission line; and
two switches coupled to input terminals of the differential test amplifier for controlling an operation of the differential test amplifier.

5. The flat panel display as claimed in claim 4, wherein the test circuit is outside the driving circuits.

6. The flat panel display as claimed in claim 4, wherein the differential test amplifier has an input impedance and an amplification gain.

7. The flat panel display as claimed in claim 4, further comprising a control signal line for sending a control signal, coupled between the controller and the gate driver.
